(19) United States
(12) Patent Application Publication
(10) Pub. No.: US 2010/0048170 A1
(43) Pub. Date: Feb. 25, 2010

(54) SOFTWARE APPLICATION SECURITY ACCESS MANAGEMENT IN MOBILE COMMUNICATION DEVICES

(75) Inventors: Robin Jewsbury, Chalfont St Giles (GB); Richard Hyndman, London (GB); David Mannl, London (GB); Anthony Alexander, London (GB)

Correspondence Address: BAKER & DANIELS LLP;111 E. WAYNE STREET, SUITE 800, FORT WAYNE, IN, 46802, US

(73) Assignee: T-MOBILE INTERNATIONAL AG & CO. KG, Bonn (DE)

(21) Appl. No.: 12/491,662

(22) Filed: Jun. 25, 2009

Related U.S. Application Data
(63) Continuation of application No. 11/577,522, now abandoned.

(30) Foreign Application Priority Data
Nov. 2, 2004 (GB) 0424263.2

(51) Int. Cl. H04M 1/66

(52) U.S. Cl. 455/411

(57) ABSTRACT

The present invention relates to method and system for software application security access management in mobile communication devices having a software services component and an interface component, the interface component having at least one interface for providing access to the software services component for enabling application software to be installed, loaded, and run on the mobile communication device, the method comprising: receiving in a security access manager a request from a requesting application software to access the software services component; determining in a security module if the request should be granted by verifying the authenticity of the software application by means of a signature; and if the request is granted, granting access to the requested software services component via the at least one interface.

The present invention generally relates to improvements in user interfaces UI for software application in mobile communication devices, and, more particularly, to a method and system for software application security access management in mobile communication devices.

Modern cellular telecommunication devices have a high degree of complexity. Currently, so-called “third generation” (3G) systems are being developed for future mobile telecommunications systems. 3G systems will combine high-speed Internet access with traditional voice communication, and will provide a user with access to Internet browsing, streaming audio/video, positioning, video conferencing and many other capabilities in addition to voice communication. The drastically increased functionality that is being included in cellular telecommunications systems via the 3GPP standardization has placed substantial demands on the developers of mobile communication devices to be used in the systems. Traditionally, manufacturers of mobile communication devices have designed, fabricated and marketed substantially complete mobile communication devices that include all the hardware and software needed for basic operation of the mobile communication device as well as the hardware and software needed to provide the features and capabilities desired by the manufacturer or a particular user based on their perception of market needs. Such an approach does not provide the flexibility to quickly adapt to rapid changes in market demands or to satisfy the diverse requirements of multiple users Recognizing the inadequacies of traditional procedures for designing and fabricating mobile communication devices, a mobile communication device assembly has been developed that includes a plurality of functionally complementary units of software and hardware that can be marketed as a unit to a plurality of users. Each user can then Install, load, and run his own application software into the assembly to provide a tailored system for a mobile communication device that meets the user's own particular needs.

The documents US 2004/193917 A1 and WO 2004/053618 A2 both disclose a software application security access management method for controlling access to a mobile communication device having a software services component and an interface component, the interface component having at least one interface for providing access to the software services component for enabling application software to be installed, loaded, and run on the mobile communication device, the method comprising: receiving in a security access manager a request from a requesting application software to access the software services component; determining in a security module if the request should be granted by verifying the authenticity of the software application by means of a signature and if the request is granted, granting access to the requested software services component via the at least one interface.

It is the object of the present invention to enable users of Of-the-shelf scripting software (e.g. Flash) to be used to create applications which securely access cellular phone APIs and mobile network APIs.

This object is achieved by providing a method and system as claimed in the independent claims.

Preferred embodiments and advantageous features of the invention are disclosed in the dependent claims.

Generally the present invention provides a method and system for software application security access management in mobile communication devices having a software services component and an interface component, the interface component having at least one interface for providing access to the software services component for enabling application software to be installed, loaded, and run on the mobile communication device, the method comprising: receiving in a security access manager a request from a requesting application software to access the software services component; determining in a security module if the request should be granted by verifying the authenticity of the software application by means of a signature, and if the request is granted, granting access to the requested software services component via the at least one interface.

More particularly, the invention is based on a system for making the applications secure without having to change the off-the-shelf scripting User Interface software package. In this way one can take any off-the-shelf scripting package and give it access to powerful phone and network APIs in a secure manner. To achieve this a security module is provided which acts as the security manager.

The security module manages/checks the security of the software application and informs the local web server which acts as a security broker to allow access to the phone and/or network APIs which need to be protected.

The system and method of operation of the invention, together with additional objects and advantages thereof, will be best understood from the following description of a specific embodiment when read in connection with the accompanying drawings.

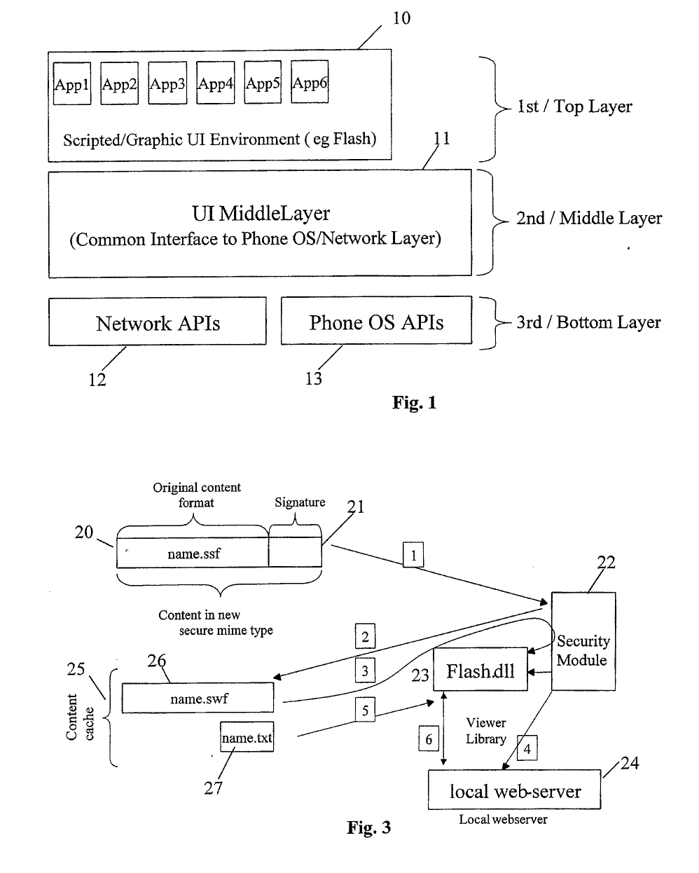

FIG. 1 is a block diagram that schematically illustrates a system with three layers for a mobile communication device for a cellular telecommunications system.

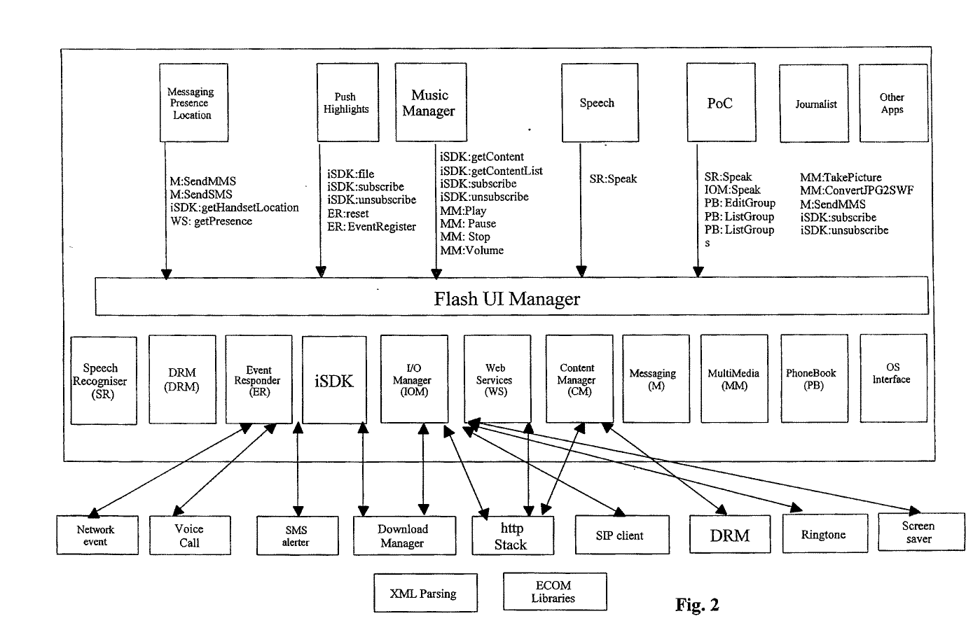

FIG. 2 is a further breakdown of the three layers according to FIG. 1 with specific examples of applications and APIs at each level.

FIG. 3 is a block diagram that shows the process on a simple example.

The invention is based on a development environment tool that allows rapid development of mobile applications without knowledge of coding the complicated coding techniques current used in mobile phones. The present example has been developed around the use of Macromedia® Flash®, but the concepts used are applicable to any rapid development environment tool such as a scripting language for a mobile phone.

A flash application is a web application that uses Flash® to collect user information, send that information to a server to process, and display the results. A typical flash procedure and information flow is as follows:

Flash® receives user input through a custom Flash® user interface. ActionScript(® formats the user input into data. The formatted data is sent to a (local) web server. The (local) web server receives the data and passes it to an application server (for example, JSP, Perl, ColdFusion, ASP, PHP). The application server splits up and processes the data. The application server submits its results to the (local) web server. The (local) web server sends its results to the Flash® application in the browser. Flash receives the formatted data. ActionScript® reads the data and changes the application based on the results.

FIG. 1 is a block diagram that schematically illustrates a system for a mobile communication device for a wireless telecommunications system to assist in explaining principles of the present invention. The system generally consists of three layers. The first layer 10 comprises a scripted/graphic user interface environment (top layer). By way of example the top layer is shown as Flash®. Flash® tools allow rapid development of user interfaces in connection with a scripting language called ActionScript®. Content providers external to the telecommunications network operators/providers or mobile phones manufacturers can generate such applications. Once a application is developed the network operator/provider would sign them which would permit them to use the network and phone application programming interfaces (APIs). The APIs gain access to functional software units of the mobile phone for providing services that are offered to users via the user interface component. There are hardware components (not shown) including a set of hardware units that are associated with and controlled by their respective functional software. The second (middle) layer 11 is the UI middle layer or common interface to Phone OS/Network layer. The middle layer 11 allows the applications developed in the top layer to access phone functions and network functions. The middle layer 11 controls access to at least one phone API 12 for network API 13 for installing, loading, and running one or more applications in the mobile communication device assembly, isolates the mobile communication device assembly from the applications, and provides various other services for the applications.

The third (bottom) layer consists of the APIs 12, 13 to the Network and Phone.

FIG. 2 shows a further breakdown of the three layers with specific examples of applications and APIs at each level. There are applications in the top layer, like messaging presence location, music manager, etc. These applications would use the phones APIs, e.g. Speech recognizer, event responder, Content Manager, etc., and/or network APIs. Like network event, voice call, SMS alerter, etc. The flash UI Security Manager allows the applications to access the phone functions and network functions in a secure manner. These are just examples. The concept according to the present invention is completely extensible and can be transferred to any development environment.

In other words, the present invention enables the network operator/provider to control the access to the phone operating system and the network APIs. For this reason the system will implement a security signing system which is described below. The complication of implementing this security system is that since the content viewer (in this case Flash.dll) is an off-the-shelf component which has no security system implemented, the components implemented by the network operator/provider have to implement the security.

The diagram of FIG. 3 shows how the system according to the present invention works:

The components used in the system are as follows:
SSF file 20: The SSF file 20 is a Secure Signed Flash file. This is original content (SWF) with a signature 21 (encrypted checksum). A recogniser in the phone associates the mime type of this file with the phone's security module.
Security Module 22: The security module 22 is the parent of the off-the-shelf product whose content is made secure (in this case “Flash.dll”)
Flash DLL 23: The Flash DLL 23 is the off-the-shelf component user interface 23 who functionality cannot be directly changed and which is made secure.
Local web-server 24: The local web server 24 provides the interface to the Middleware software—it can be talked to via http connections.
Content Cache 25: The content cache 25 consists of the files which have been processed by the security module and have passed the signature check. The cache contains two kind files for every SSF file. The two kinds of files are:
name.swf 26: This file includes the original content which the viewer (flash.dll) can read.
name.txt 27: This file is a name/value pair file which contained the signature which is read by the scripting language in the viewer.

With reference to FIG. 3 the sequence of events numbered in the diagram are described:

Step 1: The security module 22 loads a special file which tells it all SSF files 20 which need to be cached for this application and the first SWF file to run. The security module 22 either creates the cached copies or checks that the copies have previously been cached correctly. This checking may include some tamper proof checks on the cache directory 25. On faster phones, pre-caching may not be necessary and the transfer to the cache for loading into the flash player may be done file by file on the fly.

Step 2: In order to create a cached file the security module 22 takes off the signature 21 from the SSF file 20 and checks that it corresponds correctly to the original content SWF file 26 stored in the content cache 25. The signature 21 is preferably stored at the beginning of the file 20. Then the security module 22 creates a txt file 27 which contains a name value pair signature=sig-value where the sig-value is the signature plus a random number.

Step 3: The security module 22 loads the cached file 26 and make the loaded data available to the user interface 23, e.g. Flash.dll. It again may perform tamper checks on the cache directory 25 if it is not creating the cache on the fly.

Step 4: The security module 22 sends the signature for this file 26 plus the random number generated above to the local web server 24 by opening a socket to it.

Step 5: Within the file name.swf 26 is a script which reads the associated signature out of name.txt file 27 and the random number stored in it.

Step 6: When the script wants to call Middleware APIs it uses a local host URL to connect to the local web server 24. The URL contains a string representing the object to be instantiated in the middleware plus parameters for that object plus the signature and random and name of the file. The local web server 24 checks that the signature has already been received from the security module (in Step 4) in order to authenticate this scripts use.

1. A software application security access management method for controlling access to a mobile communication device having a software services component and an interface component, the interface component having at least one interface for providing access to the software services component for enabling application software to be installed, loaded, and run on the mobile communication device, the method comprising;
receiving in a security access manager a request from a requesting application software to access the software services component; determining in a security module if the request should be granted by verifying the authenticity of the software application by means of a signature;
and if the request is granted, granting access to the requested software services component via the at least one interface,
characterized in that the security module creates a name/value pair file which contains a name value pair signature=sig-value where the sig-value is the signature plus a random number.

2. Method according to claim 1, wherein the security module loads a operating file which provides it with a list of secure signed files which need to be cached for this application and the first secure signed file to run.

3. Method according to claim 1, wherein the security module either creates cached copies of the secure signed files or checks that the copies have previously been cached correctly.

4. Method according to claim 1, wherein the security module creates a cached original content file by removing a signature from the secure signed file and checks that it corresponds correctly to the original content file.

5. Method according to claim 1, wherein the signature is preferably stored at the beginning of the secure signed file.

6. Method according to claim 1, wherein the security module loads the cached original content file and make the loaded data available to the user interface.

7. Method according to claim 1, wherein the security module sends the signature for the original content file and the random number to a local web server.

8. Method according to claim 4, wherein within the original content file is a script which reads the associated signature out of original content file and the random number stored in it.

9. Method according to claim 8, wherein the script uses a local host URL to connect to the local web server for calling middleware APIs, the URL contains a string representing the object to be instantiated in the middleware, parameters for that object, the signature, the random number and name of the file.

10. Method according to claim 9, wherein the local web server checks that the signature has already been received from the security module, and authenticates the use of the script file.

11. A system for software application security access management in mobile communication devices, comprising a software services component and an interface component, the interface component having at least one application programming interface for providing access to the software services component for enabling application software to be installed, loaded, and run in the mobile communication device; and a security access manager for controlling access to the software services component by a requesting application software via the at least one interface, the security access manager comprising a security module for receiving a request from the requesting application software to access the software services component and for verifying security of the requesting application software; and wherein the requesting application software is granted access to the software services component via the at least one interface if its security and authenticity is approved, characterized in a name/value pair file created by the security module which contains a name value pair signature=sig-value where the sig-value is the signature plus a random number.

12. System according to claim 11, wherein the request includes an identification of the requesting application software by means of a signature.

13. System according to claim 11, wherein the security access manager comprises a content cache for maintaining a record of files which have passed the security verification.

14. System according to claim 11, wherein the interface component is comprised in a middleware user interface services layer.

15. Method according to claim 2, wherein the security module either creates cached copies of the secure signed files or checks that the copies have previously been cached correctly.

16. Method according to claim 2, wherein the security module creates a cached original content file by removing a signature from the secure signed file and checks that it corresponds correctly to the original content file.

17. Method according to claim 3, wherein the security module creates a cached original content file by removing a signature from the secure signed file and checks that it corresponds correctly to the original content file.

18. Method according to claim 2, wherein the signature is preferably stored at the beginning of the secure signed file.

19. Method according to claim 3, wherein the signature is preferably stored at the beginning of the secure signed file.

20. Method according to claim 4, wherein the signature is preferably stored at the beginning of the secure signed file.
